(19) United States
(12) Patent Application Publication
(10) Pub. No.: US 2023/0135174 A1
(43) Pub. Date: May 4, 2023

(54) DRIVING ASSISTANCE DEVICE

(71) Applicant: TOYOTA JIDOSHA KABUSHIKI KAISHA, Toyota-shi Aichi-ken (JP)

(72) Inventors: Hiroaki Ito, Nisshin-shi Aichi-ken (JP); Yoshitaka Kijima, Toyota-shi Aichi-ken (JP); Yoshiki Tatebe, Toyota-shi Aichi-ken (JP)

(73) Assignee: TOYOTA JIDOSHA KABUSHIKI KAISHA, Toyota-shi Aichi-ken (JP)

(21) Appl. No.: 17/899,830

(22) Filed: Aug. 31, 2022

(30) Foreign Application Priority Data
Oct. 29, 2021 (JP) 2021-177318

(51) Int. Cl. B60W 30/14; B60W 50/14; G06V 20/58; G06V 10/56

(52) U.S. Cl. CPC B60W 30/146; B60W 50/14; G06V 20/584; G06V 10/56; B60W 2050/143; B60W 2050/146; B60W 2420/42; B60W 2555/60; B60W 2556/40

(57) ABSTRACT

A driving assistance device includes a traffic light determination unit that determines whether a traffic light state in front of a subject vehicle is in a passage prohibition state, a passage permission state, or a signal transition state, a driving assistance unit that provides driving assistance corresponding to the traffic light state when it is determined that the traffic light state is in the passage prohibition state, and a right or left turn operation determination unit that determines whether the subject vehicle is in the middle of a right or left turn operation. Even when it is determined that the traffic light state in front of the subject vehicle is in the passage prohibition state, when it is determined that the subject vehicle is in the middle of the right or left turn operation, the driving assistance unit does not provide the driving assistance corresponding to the traffic light state.

### CROSS-REFERENCE TO RELATED APPLICATION

This application claims priority to Japanese Patent Application No. 2021-177318 filed on Oct. 29, 2021, incorporated herein by reference in its entirety.

### BACKGROUND

### 1. Technical Field

The present disclosure relates to a driving assistance device.

### 2. Description of Related Art

In recent years, Japanese Unexamined Patent Application Publication No. 2021-047565 is known as a technical document relating to a driving assistance device. This publication discloses a driving assistance device that displays a notification to notify a driver that a traffic light is in a red light at a position at which the notification is visible to the driver when the traffic light in front of a subject vehicle is in a red light.

### SUMMARY

When the subject vehicle enters an intersection at the green light that the subject vehicle is traveling and turns right or left, a traffic light in front of the vehicle after the vehicle has turned right or left is often in a red light. Even in such a case, when the driver is notified or looks at a display regarding the red traffic light, there is an issue in that the driver may be unnecessarily warned.

A drive assistance device according to an aspect of the present disclosure provides driving assistance to a driver of a subject vehicle when a traffic light state in front of the subject vehicle is in a passage prohibition state. The driving assistance device includes a traffic light determination unit configured to determine whether the traffic light state in front of the subject vehicle is in the passage prohibition state, a passage permission state, or a signal transition state based on an image captured by a front camera of the subject vehicle, a driving assistance unit configured to provide the driving assistance corresponding to the traffic light state when the traffic light determination unit determines that the traffic light state in front of the subject vehicle is in the passage prohibition state, and a right or left turn operation determination unit configured to determine whether the subject vehicle is in the middle of a right or left turn operation based on a light state of a turn signal of the subject vehicle, position information of the subject vehicle on a map and map information, or the image captured by the front camera of the subject vehicle and an image pattern of a right or left turn-dedicated lane stored in advance. The driving assistance unit is configured to, when the right or left turn operation determination unit determines that the subject vehicle is in the middle of the right or left turn operation, not provide the driving assistance corresponding to the traffic light state even when the traffic light determination unit determines that the traffic light state in front of the subject vehicle is in the middle of the passage prohibition state.

With the above configuration, even when it is determined that the traffic light state in front of the subject vehicle is in the passage prohibition state, when the right or left turn operation determination unit determines that the subject vehicle is in the middle of the right or left turn operation, the driving assistance is not provided to the driver. As a result, it is possible to suppress the execution of unnecessary driving assistance corresponding to the traffic light state in front of the subject vehicle after the subject vehicle has turned right or left at an intersection.

In the aspect, the right or left turn operation determination unit may start determining whether the subject vehicle is in the middle of the right or left turn operation when the traffic light determination unit determines that the traffic light state in front of the subject vehicle is in the passage permission state or the signal transition state. With the above configuration, when the subject vehicle enters an intersection with a traffic light, it is considered that the traffic light state in front of the subject vehicle is in the passage permission state or the signal transition state. Therefore, when it is determined that the traffic light state in front of the subject vehicle is in the passage permission state or the signal transition state, by starting the determination of whether the subject vehicle is in the middle of the right or left turn operation, it is possible to avoid determining whether the subject vehicle is in the middle of the right or left turn operation at an unnecessary time.

In the aspect, the driving assistance unit does not have to provide the driving assistance corresponding to the traffic light state during a certain period after the right or left turn operation determination unit determines that the subject vehicle is in the middle of the right or left turn operation, regardless of a determination result of the traffic light determination unit. With the above configuration, the time when it is determined that the subject vehicle is in the middle of the right or left turn operation and the time when the traffic light is in front of the subject vehicle after the subject vehicle has turned right or left at the intersection may be different. Therefore, by not providing driving assistance corresponding to the traffic light state regardless of the determination result of the traffic light determination unit during the certain period after it is determined that the subject vehicle is in the middle of the right or left turn operation, it is possible to appropriately suppress the execution of unnecessary driving assistance corresponding to the traffic light state in front of the subject vehicle after the subject vehicle has turned right or left at the intersection.

With each aspect of the present disclosure, it is possible to suppress the execution of unnecessary driving assistance corresponding to a traffic light state in front of the subject vehicle after the subject vehicle has turned right or left at an intersection.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a driving assistance device according to an embodiment;

FIG. 2 is a diagram for illustrating a situation in which a subject vehicle turns right at an intersection;

FIG. 3 is a flowchart illustrating an example of a driving assistance prohibition determination process; and

FIG. 4 is a flowchart illustrating an example of a driving assistance execution process.

### DETAILED DESCRIPTION OF EMBODIMENTS

Hereinafter, embodiments of the disclosure will be described with reference to the drawings.

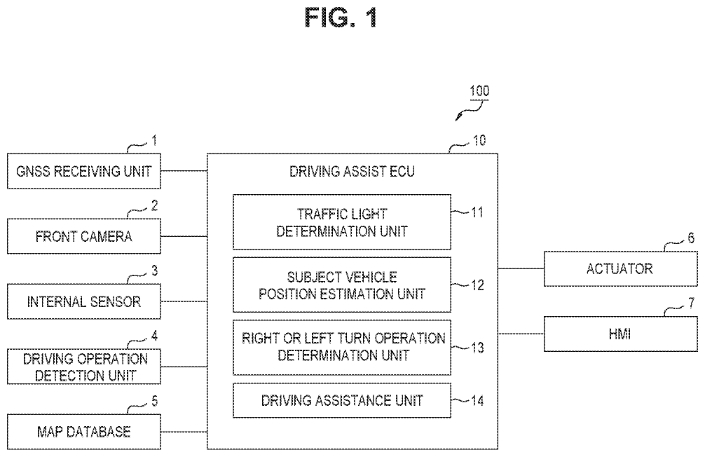

A driving assistance device 100 illustrated in FIG. 1 is a device which is mounted on a vehicle (subject vehicle) such as a passenger car and which assists a driver with driving the subject vehicle. The driving assistance device 100 provides driving assistance to the driver according to the light state of a traffic light in front of the subject vehicle. The light state of the traffic light includes a passage permission state (for example, a green light) that permits the passage of a vehicle, a passage prohibition state (for example, a red light) that prohibits the passage of a vehicle, and a signal transition state (for example, a yellow signal) that transitions from a passage permission state to a passage prohibition state. The signal transition state does not necessarily have to be included in the light state of the traffic light.

Configuration of Driving Assist Device

Hereinafter, the configuration of the driving assistance device 100 will be described with reference to the drawings. As illustrated in FIG. 1, the driving assistance device 100 includes a driving assistance electronic control unit (ECU) 10 that comprehensively manages the device. The driving assistance ECU 10 is an electronic control unit having a central processing unit (CPU), a read only memory (ROM), a random access memory (RAM), and the like. In the driving assistance ECU 10, for example, various functions are realized by executing a program stored in the ROM on the CPU. The driving assistance ECU 10 may be composed of a plurality of electronic units.

The driving assistance ECU 10 is connected to a global navigation satellite system (GNSS) receiving unit 1, a front camera 2, an internal sensor 3, a driving operation detection unit 4, a map database 5, an actuator 6, and a human machine interface (HMI) 7.

The GNSS receiving unit 1 measures the position (for example, the latitude and longitude of the subject vehicle) of the subject vehicle by receiving signals from three or more positioning satellites. The GNSS receiving unit 1 transmits the measured position information of the subject vehicle to the driving assistance ECU 10.

The front camera 2 is a camera for taking an image of the front of the subject vehicle. The front camera 2 is provided, for example, on the back side of the windshield of the subject vehicle. The front camera 2 transmits an image captured in front of the subject vehicle to the driving assistance ECU 10. The front camera 2 may be a monocular camera or a stereo camera.

The internal sensor 3 is a detection device that detects the traveling state of the subject vehicle. The internal sensor 3 includes a vehicle speed sensor, an acceleration sensor, and a yaw rate sensor. The vehicle speed sensor is a detection device that detects the speed of the subject vehicle. The vehicle speed sensor, for example, may be provided on a wheel of the subject vehicle or a drive shaft that rotates integrally with the wheel and detects the rotation speed of the wheel. The vehicle speed sensor transmits the detected vehicle speed information (wheel speed information) to the driving assistance ECU 10.

The acceleration sensor is a detection device that detects the acceleration of the subject vehicle. The acceleration sensor may include, for example, a front-rear acceleration sensor that detects acceleration in a front-rear direction of the subject vehicle and a lateral acceleration sensor that detects the lateral acceleration of the subject vehicle. The acceleration sensor, for example, transmits the acceleration information of the subject vehicle to the driving assistance ECU 10. The yaw rate sensor is a detection device that detects the yaw rate (rotational angular velocity) around the vertical axis of the center of gravity of the subject vehicle. The yaw rate sensor may be, for example, a gyro sensor. The yaw rate sensor transmits the detected yaw rate information of the subject vehicle to the driving assistance ECU 10.

The driving operation detection unit 4 is a detection device that detects the driving operation of the subject vehicle performed by the driver. The driving operation detection unit 4 includes an accelerator pedal sensor or a turn signal sensor. The driving operation detection unit 4 may include both an accelerator pedal sensor and a turn signal sensor, or may include a steering sensor, a brake pedal sensor, and a shift lever sensor.

The accelerator pedal sensor may be provided, for example, on the shaft portion of the accelerator pedal, and detects the depression force or depression amount (position of the accelerator pedal) of the accelerator pedal applied by the driver. The turn signal sensor detects the operation (on/off operation) of the turn signal performed by the driver. The turn signal sensor may be provided, for example, on the operating lever of the turn signal.

The brake pedal sensor may be provided, for example, on the shaft portion of the brake pedal, and detects the depression force or depression amount (position of the brake pedal) of the brake pedal applied by the driver. The steering sensor may be provided, for example, on the steering shaft of the subject vehicle, and detects the steering torque from the steering wheel applied by the driver. The shift lever sensor detects the shift position of the transmission.

The map database 5 is a database that stores map information. The map database 5 is formed in a storage device such as a hard disk drive (HDD) mounted on the subject vehicle, for example. The map information may include road position information, road shape information such as information indicating a curve, a type of straight line, and a curvature of a curve, position information of intersections and branch points, and position information of structures. The map information may also include traffic regulation information such as a legal speed limit associated with position information. The map database 5 may be formed on a server capable of communicating with the subject vehicle.

The actuator 6 is a device used for controlling the subject vehicle. The actuator 6 includes at least a drive actuator and a brake actuator. The actuator 6 may include a steering actuator. The drive actuator controls the amount of (throttle opening) air supplied to the engine according to the control signal from the driving assistance ECU 10, and controls the driving force of the subject vehicle. When the subject vehicle is a hybrid vehicle, in addition to the amount of air supplied to the engine, a control signal from the driving assistance ECU 10 is input to the motor as a power source to control the driving force. When the subject vehicle is an electric vehicle, a control signal from the driving assistance ECU 10 is input to a motor as a power source to control the driving force. The motor as a power source in these cases constitutes the actuator 6.

The brake actuator controls the brake system in response to a control signal from the driving assistance ECU 10 to control the braking force applied to the wheels of the subject vehicle. As the brake system, for example, a hydraulic brake system can be used. The steering actuator controls the drive of the assistance motor that controls the steering torque in the electric power steering system according to a control signal from the driving assistance ECU 10. As a result, the steering actuator controls the steering torque of the subject vehicle.

The HMI (human machine interface) 7 is an interface for inputting and outputting information between the driving assistance device 100 and the driver. The HMI 7 may include, for example, a display and a speaker. The HMI 7 performs image output from a display and audio output from a speaker in response to a control signal from the driving assistance ECU 10. The display may be a head up display (HUD) or a multi-information display provided on an instrument panel.

Next, the functional configuration of the driving assistance ECU 10 will be described. As illustrated in FIG. 1, the driving assistance ECU 10 has a traffic light determination unit 11, a subject vehicle position estimation unit 12, a right or left turn operation determination unit 13, and a driving assistance unit 14. In addition, a part of the functions of the driving assistance ECU 10 described below may be executed in a server capable of communicating with the subject vehicle.

The traffic light determination unit 11 determines the light state of the traffic light in front of the subject vehicle based on the image captured by the front camera 2. The traffic light determination unit 11 determines whether the traffic light state in front of the subject vehicle is in the passage prohibition state, the passage permission state, or the signal transition state. The traffic light determination unit 11 performs the determination of the traffic light by a well-known image processing method such as pattern matching or deep learning.

In the case of a traffic light having an arrow light, the traffic light determination unit 11 determines whether the traffic light state is in the passage prohibition state, the passage permission state, or the signal transition state, taking into account the light state of the arrow light. The traffic light determination unit 11 recognizes whether the traveling lane of the subject vehicle is a right turn-dedicated lane or a left turn-dedicated lane as necessary, and determines that passage is permitted when the corresponding arrow light is lit. A well-known method can be adopted for the determination of the light state of the traffic light with the arrow light.

The subject vehicle position estimation unit 12 estimates the position of the subject vehicle on the map based on the position information of the GNSS receiving unit 1 and the map information of the map database 5. Further, the subject vehicle position estimation unit 12 may estimate the position of the subject vehicle by simultaneous localization and mapping (SLAM) technology by using the position information of a fixed obstacle such as a utility pole included in the map information of the map database 5 and the captured image of the front camera 2. The detection result of the millimeter-wave radar or the light detection and ranging (LIDAR) mounted on the subject vehicle may be used for the subject vehicle position estimation by SLAM. The subject vehicle position estimation unit 12 may also estimate the position of the subject vehicle on the map by a well-known method such as dead reckoning.

The right or left turn operation determination unit 13 determines whether the subject vehicle is in the middle of a right or left turn operation. The right or left turn operation determination unit 13 determines whether the subject vehicle is in the middle of a right or left turn operation based on the light state of the turn signal of the subject vehicle, the position information and map information of the subject vehicle on the map, the image captured by the front camera of the subject vehicle, and the image pattern of the right or left turn-dedicated lane stored in advance. The right or left turn operation determination unit 13 may start determining the right or left turn operation of the subject vehicle when the traffic light determination unit 11 determines that the traffic light state in front of the subject vehicle is in the passage permission state or the signal transition state. The right or left turn operation determination unit 13 may always determine whether the vehicle is in the middle of the right or left turn operation when the driving assistance function is turned on, or may start the determination of whether the vehicle is in the middle of the right or left turn operation under other conditions.

The right or left turn operation determination unit 13 recognizes, for example, the light state (whether the signal light is lit and the lighting direction) of the direction indicator of the subject vehicle from the driver's operation of the direction indicator which the driving operation detection unit 4 detected. The right or left turn operation determination unit 13 may determine that the subject vehicle is in the middle of a right or left turn operation when the direction indicator of the subject vehicle on either the right or left side is lit.

When the right or left turn operation determination unit 13 recognizes that the subject vehicle is traveling in the right turn-dedicated lane or the left turn-dedicated lane based on the position information and the map information of the subject vehicle on the map, it may be determined that the subject vehicle is in the middle of the right or left turn operation. It is assumed that the map information includes the position information of the right turn-dedicated lane and the left turn-dedicated lane. When the right or left turn operation determination unit 13 recognizes that the subject vehicle is moving from the traveling lane of the subject vehicle to the lane that intersects the traveling lane at the intersection based on the position information and the map information of the subject vehicle on the map, it may be determined that the subject vehicle is in the middle of the right or left turn operation.

When the right or left turn operation determination unit 13 recognizes that the subject vehicle is traveling in the right turn-dedicated lane or the left turn-dedicated lane based on the image captured by the front camera of the subject vehicle and the image pattern of the right or left turn-dedicated lane stored in advance, it may be determined that the subject vehicle is in the middle of the right or left turn operation. The image pattern of the right or left turn-dedicated lane is, for example, an image pattern of a road surface mark such as an arrow indicating a right turn-dedicated lane or a left turn-dedicated lane.

In addition to the light state of the direction indicator of the subject vehicle, the right or left turn operation determination unit 13 may determine the right or left turn operation of the subject vehicle in consideration of the lighting direction (right direction or left direction) of the direction indicator of the preceding vehicle. In this case, the right or left turn operation determination unit 13 does not determine that the subject vehicle is in the middle of the right or left turn operation only by lighting of the direction indicator of the subject vehicle. For example, the right or left turn operation determination unit 13 recognizes the lighting direction of the direction indicator of the subject vehicle from the detection result of the driving operation detection unit 4, and recognizes the lighting direction of the direction indicator of the preceding vehicle based on the image captured by the front camera of the subject vehicle. The right or left turn operation determination unit 13 determines that the subject vehicle is in the middle of the right or left turn operation when the lighting direction of the direction indicator of the subject vehicle and the lighting direction of the direction indicator of the preceding vehicle are the same.

The right or left turn operation determination unit 13 may determine whether the vehicle is in the middle of the right or left turn operation of the subject vehicle based on the light state of the direction indicator of the subject vehicle and the image captured by the front camera of the subject vehicle. The right or left turn operation determination unit 13 may recognize a lane boundary line (including an extended lane boundary line of the traveling lane that straddles the intersection) of the traveling lane from the captured image of the front camera of the subject vehicle at the start of lighting of the direction indicator of the subject vehicle, and may determine that the subject vehicle is in the middle of the right or left turn operation from the change rate in the angle between the traveling direction of the subject vehicle and the lane boundary line of the traveling lane in the image captured by the front camera.

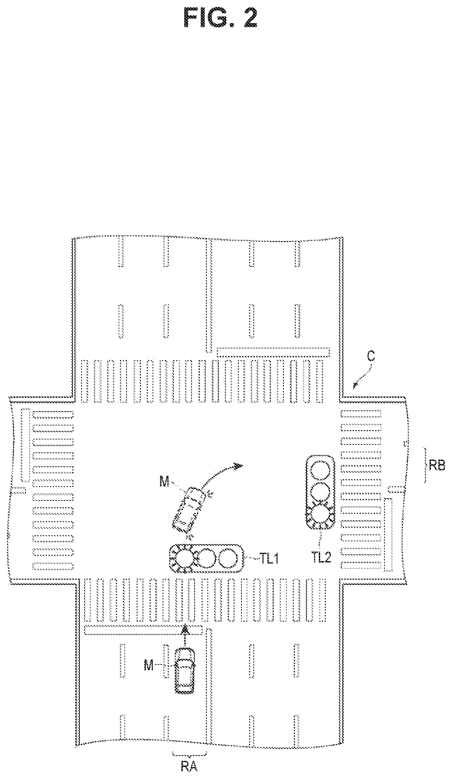

FIG. 2 is a diagram for illustrating a situation in which the subject vehicle turns right at an intersection. FIG. 2 shows an intersection C, a subject vehicle M, a traveling lane RA of the subject vehicle M, and a lane RB at the right turn destination of the subject vehicle M. Further, the subject vehicle M during the middle of the right or left turn operation is shown by a broken line, and a traffic light TL1 corresponding to the traveling lane RA and a traffic light TL2 corresponding to the lane RB at the right turn destination are shown. The traffic light TL1 state is in a passage permission state, and the traffic light TL2 state is in a passage prohibition state. The right or left turn operation determination unit 13 determines that the subject vehicle M is in the middle of the right or left turn operation from, for example, the light state of the direction indicator of the subject vehicle M.

When the traffic light determination unit 11 determines that the traffic light state in front of the subject vehicle is in the passage prohibition state, the driving assistance unit 14 provides driving assistance corresponding to the traffic light state. The content of driving assistance is not particularly limited.

The driving assistance may be a warning to notify the driver that the traffic light state is in the passage prohibition state, may be a deceleration operation assistance to support the deceleration operation of the driver of the subject vehicle, or may be deceleration assistance that automatically performs deceleration. The warning is performed by audio output and/or image display via the HMI 7. The deceleration operation assistance and the deceleration assistance are executed under the control of the actuator 6.

Even when the traffic light determination unit 11 determines that the traffic light state in front of the vehicle is in the passage prohibition state, when the right or left turn operation determination unit 13 determines that the subject vehicle is in the middle of the right or left turn operation, the driving assistance unit 14 does not provide driving assistance corresponding to the traffic light state. In the situation illustrated in FIG. 2, since the right or left turn operation determination unit 13 determines that the subject vehicle is in the middle of the right or left turn operation, the driving assistance unit 14 can avoid unnecessary driving assistance corresponding to the traffic light TL2 state during the right turn operation even when the traffic light TL2 state in front of the subject vehicle M (after the subject vehicle M has turned right) is in the passage prohibition state.

The driving assistance unit 14 may be in a mode in which the driving assistance unit 14 does not provide driving assistance corresponding to the traffic light state during a certain period of time from the time when the right or left turn operation determination unit 13 determines that the subject vehicle is in the middle of the right or left turn operation regardless of the determination result of the traffic light determination unit 11. The certain period is not particularly limited, but may be 30 seconds, one minute, or three minutes or more.

The driving assistance unit 14 may be in a mode in which, when the right or left turn operation determination unit 13 determines that the subject vehicle is in the middle of the right or left turn operation, the driving assistance unit 14 does not provide driving assistance corresponding to the traffic light state from the time when the right or left turn operation determination unit 13 determines that the subject vehicle is in the middle of the right or left turn operation until a certain period elapses after it is determined that the subject vehicle has completed the right or left turn operation, regardless of the determination result of the traffic light determination unit 11. For example, when the steering angle of the subject vehicle becomes less than a second threshold value after the steering angle of the subject vehicle becomes equal to or more than the first threshold value in either the right or left direction, the driving assistance unit 14 may determine that the right or left turn operation of the subject vehicle has been completed. The second threshold value may be smaller than the first threshold value. The first threshold value and the second threshold value are preset threshold values. The certain period is not particularly limited, but may be 10 seconds, 15 seconds, 20 seconds, or one minute or more. The yaw rate may be adopted instead of the steering angle. In addition, a well-known method can be adopted for determining whether the right or left turn operation has been completed.

Process of Driving Assist Device

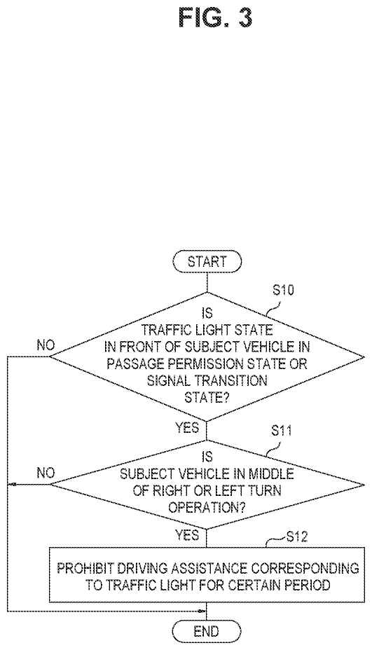

Next, the process of the driving assistance device 100 according to the present embodiment will be described with reference to the drawings. FIG. 3 is a flowchart illustrating an example of the driving assistance prohibition determination process. The driving assistance prohibition determination process is executed when the driving assistance corresponding to the traffic light state is turned on by the user setting.

As illustrated in FIG. 3, as S10, the driving assistance ECU 10 of the driving assistance device 100 determines whether the traffic light state in front of the subject vehicle is in the passage prohibition state, the passage permission state, or the signal transition state by the traffic light determination unit 11. The traffic light determination unit 11 makes the above determination based on the image captured by the front camera 2. When it is determined that the traffic light state in front of the subject vehicle is in the passage permission state or the signal transition state (S10: YES), the driving assistance ECU 10 shifts to S11. When it is not determined that the traffic light state in front of the subject vehicle is in the passage permission state or the signal transition state (S10: NO), the driving assistance ECU 10 ends the current driving assistance prohibition determination process.

In S11, the driving assistance ECU 10 determines whether the subject vehicle is in the middle of the right or left turn operation by the right or left turn operation determination unit 13. The right or left turn operation determination unit 13 makes the above determination based on the light state of the turn signal of the subject vehicle, the position information and map information of the subject vehicle on the map, the image captured by the front camera of the subject vehicle, and the image pattern of the right or left turn-dedicated lane stored in advance. When it is determined that the subject vehicle is in the middle of the right or left turn operation (S11: YES), the driving assistance ECU 10 shifts to S12. When it is not determined that the subject vehicle is in the middle of the right or left turn operation (S11: NO), the driving assistance ECU 10 ends the current driving assistance prohibition determination process.

In S12, the driving assistance ECU 10 prohibits driving assistance corresponding to the traffic light state by the driving assistance unit 14 during a certain period. In this case, the driving assistance to be prohibited is not limited to driving assistance corresponding to the traffic light state determined in S10, but is driving assistance corresponding to states of all traffic lights. Then, the driving assistance ECU 10 ends the current driving assistance prohibition determination process.

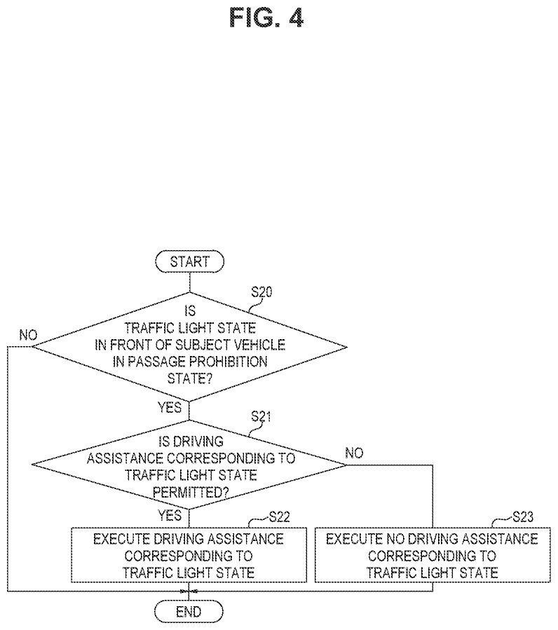

FIG. 4 is a flowchart illustrating an example of a driving assistance execution process. The driving assistance execution process is executed when the driving assistance corresponding to the traffic light state is turned on by the user setting.

As illustrated in FIG. 4, the driving assistance ECU 10 determines, in S20, whether the traffic light state in front of the subject vehicle is in the passage prohibition state, the passage permission state, or the signal transition state by the traffic light determination unit 11. When it is determined that the traffic light state in front of the subject vehicle is in the passage prohibition state (S20: YES), the driving assistance ECU 10 shifts to S21. When it is not determined that the traffic light state in front of the subject vehicle is in the passage prohibition state (S20: NO), the driving assistance ECU 10 ends the current driving assistance execution process.

In S21, the driving assistance ECU 10 determines whether driving assistance corresponding to the traffic light state is permitted by the driving assistance unit 14. The driving assistance ECU 10 shifts to S22 when driving assistance corresponding to the traffic light state is permitted (S21: YES). The driving assistance ECU 10 shifts to S23 when driving assistance corresponding to the traffic light state is not permitted (S21: NO).

In S22, the driving assistance ECU 10 executes driving assistance corresponding to the traffic light state by the driving assistance unit 14. The driving assistance unit 14 warns the driver that the traffic light state is in the passage prohibition state through, for example, the HMI 7. The driving assistance unit 14 may transmit a control signal to the actuator 6 to provide deceleration assistance for automatically decelerating the subject vehicle by the brake actuator. Then, the driving assistance ECU 10 ends the current driving assistance execution process. In S22, the driving assistance ECU 10 determines that the driving assistance corresponding to the traffic light state is not executed, and ends the current driving assistance execution process.

With the driving assistance device 100 according to the present embodiment described above, even when it is determined that the traffic light state in front of the vehicle is in the passage prohibition state, when the right or left turn operation determination unit 13 determines that the subject vehicle is in the middle of the right or left turn operation, driving assistance is not provided to the driver. As a result, it is possible to prevent the execution of unnecessary driving assistance corresponding to the traffic light state in front of the subject vehicle after the subject vehicle has turned right or left at the intersection.

Further, according to the driving assistance device 100, when the subject vehicle enters an intersection with a traffic light, it is considered that the traffic light state in front of the subject vehicle is in a passage permission state or a signal transition state. Therefore, when it is determined that the traffic light state in front of the subject vehicle is in the passage permission state or the signal transition state, by starting the determination of whether the subject vehicle is in the middle of the right or left turn operation, it is possible to avoid determining whether the subject vehicle is in the middle of the right or left turn operation at an unnecessary time.

Furthermore, according to the driving assistance device, the time when it is determined that the subject vehicle is in the middle of the right or left turn operation and the time when the traffic light is in front of the subject vehicle after the subject vehicle has turned right or left at the intersection may be different. Therefore, by not providing driving assistance corresponding to the traffic light state regardless of the determination result of the traffic light determination unit during a certain period after it is determined that the subject vehicle is in the middle of the right or left turn operation, it is possible to appropriately prevent the execution of unnecessary driving assistance corresponding to the traffic light state in front of the subject vehicle after the subject vehicle has turned right or left at the intersection.

Although the embodiment of the disclosure is described above, the disclosure is not limited to the embodiment described above. The disclosure can be carried out in various forms with various modifications and improvements based on the knowledge of those skilled in the art, including the above-described embodiment. The disclosure is applicable to autonomous driving.

For example, the right or left turn operation determination unit 13 may start the determination of the right or left turn operation regardless of the determination result of the traffic light determination unit 11. The driving assistance ECU 10 does not necessarily have to have the subject vehicle position estimation unit 12. In some embodiments, when the subject vehicle position estimation unit 12 is not provided in the driving assistance device 100, the GNSS receiving unit 1 and the map database 5 may not be provided either. When the driving assistance device 100 does not use the light state of the turn signal for the right or left turn operation, the driving operation detection unit 4 is unnecessary.

What is claimed is:

1. A driving assistance device that provides driving assistance to a driver of a subject vehicle when a traffic light state in front of the subject vehicle is in a passage prohibition state, the driving assistance device comprising:
a traffic light determination unit configured to determine whether the traffic light state in front of the subject vehicle is in the passage prohibition state, a passage permission state, or a signal transition state based on an image captured by a front camera of the subject vehicle;
a driving assistance unit configured to provide the driving assistance corresponding to the traffic light state when the traffic light determination unit determines that the traffic light state in front of the subject vehicle is in the passage prohibition state; and
a right or left turn operation determination unit configured to determine whether the subject vehicle is in the middle of a right or left turn operation based on a light state of a turn signal of the subject vehicle, position information of subject vehicle on a map and map information, or the image captured by the front camera of the subject vehicle and an image pattern of a right or left turn-dedicated lane stored in advance,
wherein the driving assistance unit is configured to, when the right or left turn operation determination unit determines that the subject vehicle is in the middle of the right or left turn operation, not provide the driving assistance corresponding to the traffic light state even when the traffic light determination unit determines that the traffic light state in front of the subject vehicle is in the passage prohibition state.

2. The driving assistance device according to claim 1, wherein the right or left turn operation determination unit is configured to start determining whether the subject vehicle is in the middle of the right or left turn operation when the traffic light determination unit determines that the traffic light state in front of the subject vehicle is in the passage permission state or the signal transition state.

3. The driving assistance device according to claim 2, wherein the driving assistance unit is configured not to provide the driving assistance corresponding to the traffic light state during a certain period after the right or left turn operation determination unit determines that the subject vehicle is in the middle of the right or left turn operation, regardless of a determination result of the traffic light determination unit.
